(19) United States
(12) Patent Application Publication
(10) Pub. No.: US 2014/0184395 A1
(43) Pub. Date: Jul. 3, 2014

(54) COMMUNICATION DEVICE AND COMMUNICATION SYSTEM

(71) Applicant: Kabushiki Kaisha Toshiba, Tokyo (JP)

(72) Inventors: Takashi DOI, Fuchu-shi (JP); Hideki MIYASATO, Yokohama-shi (JP)

(73) Assignee: Kabushiki Kaisha Toshiba, Tokyo (JP)

(21) Appl. No.: 14/013,931

(22) Filed: Aug. 29, 2013

Related U.S. Application Data
(63) Continuation of application No. PCT/JP2013/058424, filed on Mar. 22, 2013.

(30) Foreign Application Priority Data
Dec. 28, 2012 (JP) 2012-289066

(51) Int. Cl. G08C 17/02

(52) U.S. Cl. CPC G08C 17/02
USPC 340/12.23

(57) ABSTRACT

According to one embodiment, a communication device includes a communication module and an assignment module. The communication module is configured to receive a profile in which a key for executing a command is associated with the command, and a command receivable by a reception device. The assignment module is configured to assign the receivable command and the key based on the profile.

### CROSS-REFERENCE TO RELATED APPLICATIONS

This application is a continuation of International Application No. PCT/JP2013/058424, filed on Mar. 22, 2013 which claims the benefit of priority of the prior Japanese Patent Application No. 2012-289066, filed on Dec. 28, 2012, the entire contents of which are incorporated herein by reference.

### FIELD

Embodiments described herein relate generally to a communication device and a communication system.

### BACKGROUND

In recent years, mobile devices capable of displaying high-definition video have been widely used. To deal with such sophisticated functions of the mobile devices, for example, a video transmission technology based on the Mobile High-Definition Link (MHL) standard or the like has been developed.

In this MHL standard, a remote control protocol (RCP) for realizing a remote operation between devices connected to each other by transmission and reception of a remote command is defined. An RCP transmission device transmits an RCP command to an RCP reception device, the RCP reception device executes the RCP command, and thus it is possible to perform a remote operation between devices.

However, depending on an RCP reception device, there is a case where all operations in the RCP reception device do not correspond to RCP commands. In such a case, an undefined operation occurs between an RCP transmission device and the RCP reception device.

In the RCP, it is not allowed that a third vendor or the like expands an RCP command. Accordingly, the existing RCP command may be redefined by an undefined operation or the undefined operation may be defined by a prearranged reserve command. However, in this case, it is difficult to keep compatibility of the RCP command between vendors.

In addition, generally, the RCP command is assigned to a key or a button of a remote controller of the RCP transmission device, but there is a limit to the number of keys or buttons of the remote controller. For this reason, it is necessary to assign a part of RCP commands to a software key, but such assignment to the software key is inefficient and cumbersome.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary configuration diagram of a communication system of an embodiment;

FIG. 2 is an exemplary block diagram illustrating a configuration of a digital television according to the embodiment;

FIG. 3 is an exemplary block diagram illustrating a functional configuration of the digital television by a controller of the embodiment;

FIG. 4 is an exemplary diagram illustrating an example of an RCP profile of the embodiment;

FIG. 5 is an exemplary diagram illustrating an example of a structure of an RCP code of the embodiment;

FIG. 6 is an exemplary block diagram illustrating a functional configuration of a mobile device 200 according to the embodiment;

FIG. 7 is an exemplary sequence diagram illustrating flow of an RCP command communication process by the communication system of the embodiment;

FIG. 8 is an exemplary flowchart illustrating sequence of a key reassignment process according to the embodiment;

FIG. 9 is an exemplary diagram illustrating an example of a key assignment notification screen of the embodiment; and

FIG. 10 is an exemplary diagram illustrating an example of a display screen of a reassigned software key of the embodiment.

### DETAILED DESCRIPTION

In general, according to one embodiment, a communication device comprises a communication module and an assignment module. The communication module is configured to receive a profile in which a key for executing a command is associated with the command, and a command receivable by a reception device, from the reception device for receiving the command transmitted from the communication device and executing the command. The assignment module is configured to assign the receivable command and the key based on the profile.

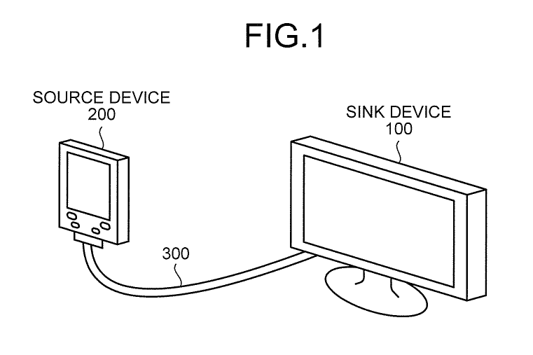

A communication device and a communication system according to one embodiment will be described in detail below with reference to the accompanying drawings. The communication system of the embodiment comprises, as illustrated in FIG. 1, a mobile device 200 and a digital television 100 that are connected to each other through a Mobile High-Definition Link (MHL) cable 300.

In the embodiment, image transmission between the mobile device 200 and the digital television 100 is realized based on the MHL standard. More specifically, in the embodiment, the mobile device 200 is a source device, the digital television 100 is a sink device, and image data is transmitted from the mobile device 200 to the digital television 100 through the MHL cable 300 by protocol of the MHL standard.

In the embodiment, a remote operation between the mobile device 200 and the digital television 100 is realized by RCP. In the embodiment, the mobile device 200 serves as an RCP reception device, and the digital television 100 serves as an RCP transmission device (a communication device). The digital television 100 transmits an RCP command that is a remote command to the mobile device 200, and the mobile device 200 receives and executes the RCP command.

In addition, in the embodiment, the digital television 100 provided with a digital broadcasting receiving tuner will be exemplified, as the communication device (the RCP transmission device). However, it is not limited to the digital television 100, may be a device such as a hard disk recorder and a set top box provided with a tuner receiving broadcast waves and processing and outputting a video to a display device connected to the outside, or may be a monitor to which a video or an audio is input from an external tuner without providing the tuner. In addition, devices other than the digital television 100, the hard disk recorder, and the set top box may be used as the RCP transmission device and the communication device.

In addition, the mobile device 200 is exemplified as the RCP reception device, but is not limited thereto. Devices other than the mobile device 200 may be used as the RCP reception device.

In addition, in the embodiment, although the mobile device 200 is the source device, and the digital television 100 is the sink device, they are examples and not limited to such combination.

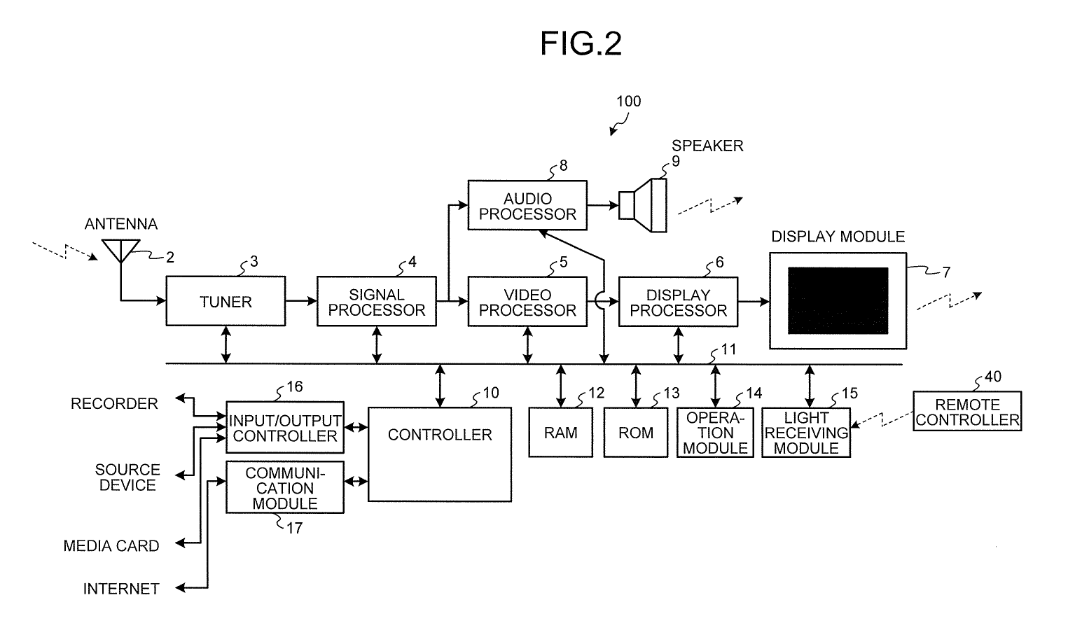

The digital television 100 of the embodiment will be explained below. The digital television 100 of the embodiment mainly comprises, as illustrated in FIG. 2, an antenna 2, a tuner 3 for receiving digital broadcasting, a signal processor 4, a video processor 5, a display processor 6, a display module 7, an audio processor 8, a speaker 9, a controller 10, a communication line 11, a random access memory (RAM) 12, a read-only memory (ROM) 13, an operation module 14, a light receiving module 15, an input/output controller 16, and a communication module 17.

The antenna 2 receives digital broadcasting, such as BS, CS, or terrestrial broadcasting. The tuner 3 selects a viewing channel designated by a user. The signal processor 4 extracts and processes, as various digital signals, a signal demodulated by the tuner 3 and a signal input by the input/output controller 16 under the control of the controller 10. The signal processor 4 separates the input signal into a video signal and an audio signal, outputs the video signal to the video processor 5, and outputs the audio signal to the audio processor 8.

The video processor 5 performs a process for adjusting the video signal input by the signal processor 4 to a correct screen size, a process for removing noise from the video signal as image quality processing for improving the image quality of video, or the like.

The display processor 6 performs a process for displaying the video signal output by the video processor 5 on the display module 7. The display processor 6 superimposes an on-screen display (OSD), such as textual information, on the video signal output by the video processor 5. The display module 7 displays the video signal on the screen. The user watches television images by watching the screen of the display module 7.

The audio processor 8 performs sound processing on the audio signal and amplifies the audio signal. The speaker 9 outputs the audio signal as sound. The user listens to television audio by listening to the sound from the speaker 9.

The controller 10 controls each of the modules of the digital television 100. The controller 10 is a processor capable of performing sequential processing. The controller 10 loads the programs stored in the ROM 13 into the RAM 12, and sequentially executes the programs to output control signals to each of the modules of the digital television 100 to thereby centrally control the operation of the digital television 100.

The communication line 11 connects the tuner 3, the signal processor 4, the video processor 5, the display processor 6, the audio processor 8, and the controller 10 to one another, and enables data exchange between the controller 10 and each of the tuner 3, the signal processor 4, the video processor 5, the display processor 6, and the audio processor 8. Specifically, the communication line 11 may be an inter-integrated circuit bus (IIC-BUS) for example. The RAM 12 and the ROM 13 store therein various types of data and exchange the data with the controller 10.

The operation module 14 is a switch for receiving an operating instruction from a user. The light receiving module 15 receives a signal sent by a remote controller 40 that has received the operating instruction from the user. The user can operate the digital television 100 and various devices connected to the digital television 100 by operating various buttons or keys of the remote controller 40. Hereinafter, the key and the button are not discriminated, and are collectively referred to as a “key”.

The communication module 17 has a function to communicate with a server connected via a network, such as the Internet. The communication module 17 sends a request for information to the server and receives the information transmitted by the server.

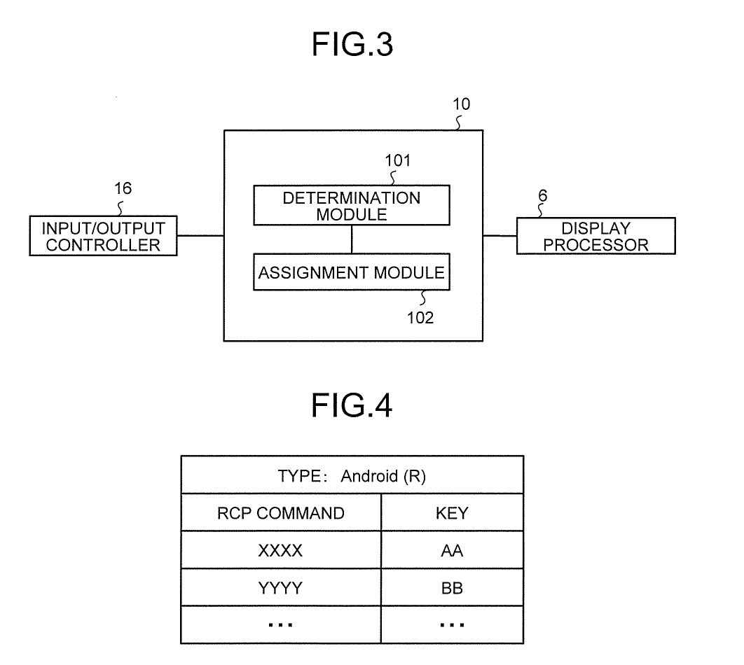

Next, functions performed by the controller 10 will be described in detail. As illustrated in FIG. 3, the digital television 100 mainly comprises a determination module 101 and an assignment module 102 as a functional configuration realized by the controller 10. In addition, in FIG. 3, for convenience of description, the display processor 6 and the input/output controller 16 illustrated in FIG. 2 are also illustrated.

In the embodiment, a remote operation between the mobile device 200 and the digital television 100 is realized by RCP. However, although the RCP command corresponds to an operation defined in CEA931C since the RCP refers to CEA931C prescribing a remote operation of a consumer electronics (CE) device, the RCP command corresponds to a part of operations of a mobile device such as Android (registered trademark) and Windows Phone (registered trademark), but does not correspond to all. When such a mobile device 200 is the RCP reception device, it is necessary to realize an operation which is undefined in CEA931C, but it is not allowed that the third vendor expands the RCP command.

For this reason, in order to realize the operation which is undefined in CEA931C, it is necessary to redefine the existing RCP command corresponding to the operation defined in CEA931C, to an undefined operation, or to assign an undefined operation to a reserve command (a reservation command) prearranged in RCP. However, when redefining or assigning is performed, it is difficult to keep compatibility of the RCP command between vendors.

In addition, generally, the RCP commandmay be fixedly assigned to a key of the remote controller 40 of the digital television 100 or the like, but there is a limit in the number of keys disposed on the remote controller 40. Accordingly, it may be difficult that all the remote operations of the mobile device 200, which is the RCP reception device, are realized by the keys of the remote controller. For this reason, the function of the remote controller may be expanded by the software key depending on devices. However, also in this case, it is not efficient that all the RCP commands are fixedly arranged, which is cumbersome.

For this reason, in the embodiment, the key assignment adapted to the mobile device 200 is stored in advance in a storage module 202 of the mobile device 200 as an RCP profile, and the RCP protocol is transmitted and used to the digital television 100 that is the RCP transmission device. In addition, the mobile device 200 transmits the RCP command receivable by the mobile device 200 to the digital television 100, and the digital television 100 reassigns keys based on the RCP profile, data of the assignment of the keys of the remote controller 40 managed by the digital television 100 and the RCP commands, and the receivable RCP command. Accordingly, the assignment of the commands is efficiently and easily performed while keeping compatibility, to reduce an undefined operation between the mobile device 200 and the digital television 100. Hereinafter, a configuration thereof will be described in detail.

In FIG. 3, the input/output controller 16 is connected to the source device through the MHL cable, and receives the video signal, the RCP profile, and the RCP code from the mobile device 200 that is the source device. Here, the RCP profile is data of the key assignment in which the RCP command of performing the operation of the mobile device 200 is associated with the key of the remote controller 40 for executing the RCP command, and is adapted to the mobile device 200. That is, the RCP profile is different according to types of the mobile device 200. As the types of such a mobile device 200, for example, there is information about a platform and an operating system (OS) of the mobile device 200, such as Android (registered trademark) and Windows Phone (registered trademark). In the embodiment, the RCP profiles different according to such a platform and OS is used, the RCP profile for Android (registered trademark) and the RCP profile for Windows Phone (registered trademark) are registered in advance in the mobile device 200 according to the mobile device 200. For example, in the RCP profile for Android (registered trademark), assignment of RCP commands and keys of the remote controller 40 of specific operations for Android (registered trademark), such as a display operation of a home screen, an operation of returning to a previous screen, a menu display operation, and a search operation is registered in addition to the assignment of the RCP command and the key in the operation defined in CEA931C.

As illustrated in FIG. 4, the RCP profile illustrates the type of the mobile device 200, which is for Android (registered trademark) in this example. In addition, in the RCP profile, the key and the RCP command are associated, and it means that the RCP command associated with the key is executed by pressing the key.

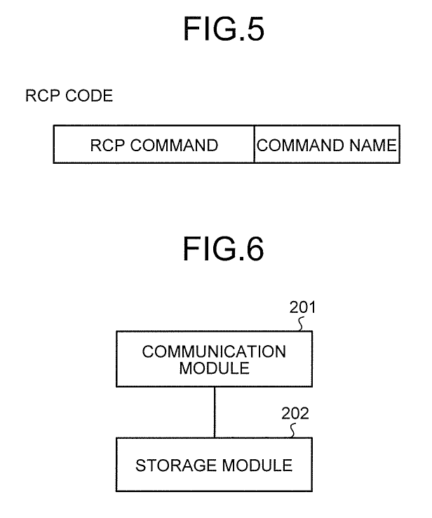

In addition, the RCP code is data in which the RCP command receivable by the mobile device 200 and the name of the command is a set. As illustrated in FIG. 5, the RCP code includes an RCP command and a command name formed of a character string for identifying the RCP command.

Returning to FIG. 3, the determination module 101 determines whether the RCP profile received from the mobile device 200 by the input/output controller 16 is supported by the digital television 100. The input/output controller 16 transmits an ACK response to the mobile device 200 when the received RCP profile is supported, and transmits a NACK response to the mobile device 200 when the received RCP profile is not supported.

Here, as a case where the RCP profile is not supported, for example, the key assigned to the RCP command is not present as the key of the remote controller 40 of the digital television 100, but it is not limited thereto.

The assignment module 102 reassigns the receivable RCP command included in the RCP code received from the mobile device 200 by the input/output controller 16, and the key of the remote controller 40, based on the RCP profile and the data of the assignment of the key of the remote controller 40 managed by the digital television 100 and the RCP command or the like. More specifically, the assignment module 102 determines whether the receivable RCP command included in the RCP code is a specific command, and assigns the receivable command to the specific key of the remote controller 40 when the receivable RCP command is the specific command. The data of the assignment of the key of the remote controller 40 managed by the digital television 100 and the RCP command is stored in advance in a storage medium such as the ROM 13.

Here, the specific RCP command may arbitrarily set, but corresponds to a command of an operation of the key of the mobile device 200 constantly displayed on the screen of the mobile device 200. For example, in the mobile device 200, when the keys of the mobile device 200 such as a “home” key of an operation of displaying a home screen, a “back” key of returning to a previous screen, a “menu” key of a menu display operation, and a “search” key of a search operation are constantly displayed on the screen of the mobile device 200, the RCP commands of such operations are specific commands.

In addition, the specific keys are keys disposed at positions in the remote controller 40 where the user easily operates the keys, for example, correspond to “blue”, “red”, “yellow”, and “green”, but are not limited thereto.

It is thought that the command constantly displayed on the operation screen of the mobile device 200 is frequently used by the user. In such a case, there is a merit of improving convenience for the user when being assigned to the key of the operation face which can constantly operated even in the remote controller 40.

In addition, the assignment module 102 assigns the receivable RCP command to any one of software keys, when the receivable RCP command is a command other than the specific RCP command and the receivable RCP command which has frequency in use of the user lower than a predetermined number of times and is a predetermined command which is not functionally often used or a predetermined command which is not functional important. In the case of the command which has the lower frequency in use and is the command which is not important, the user rarely operate the RCP command, and an influence on convenience of the user is small even without being associated with the key of the operation face of the remote controller 40.

Here, the data (the assignment data) of the assignment of the key of the remote controller 40 managed by the digital television 100 and the RCP command may be data in which the RCP command of the command group formed of the RCP command of the operation defined in CEA931C and executable even in the mobile device 200 and the key are assigned.

When the receivable RCP command included in the RCP code received from the mobile device 200 is a command other than the RCP command constituting the command group of the assignment data, that is, the receivable RCP command is a command undefined in CEA931C, the assignment module 102 may reassign the key assigned in advance to the RCP command defined in CEA931C with respect to the assignment data, to the receivable command undefined in CEA931C. However, it is not limited thereto, and the assignment module 102 may be configured so as to reassign the RCP command receivable by the mobile device 200 to a key other than the key assigned to the command defined in CEA931C. Alternatively, the assignment module 102 may be configured to change reassignment to the key already assigned to the command defined in CEA931C and reassignment to a key other than the already assigned key, of the RCP command receivable by the mobile device 200, by an instruction of the user.

The display processor 6 displays a reassignment state of the receivable RCP command and the key of the remote controller 40 on the display module 7 by OSD, to notify the user.

Next, a functional configuration of the mobile device 200 will be described. As illustrated in FIG. 6, the mobile device 200 of the embodiment primarily includes a communication module 201 and a storage module 202.

The storage module 202 is a storage medium such as a RAM and a flash ROM, and stores the RCP profile adapted to a type of the mobile device 200 itself and the RCP code including the RCP command receivable by the mobile device 200. The communication module 201 transmits the RCP profile and the RCP code of the storage module 202 to the digital television 100 through the MHL cable.

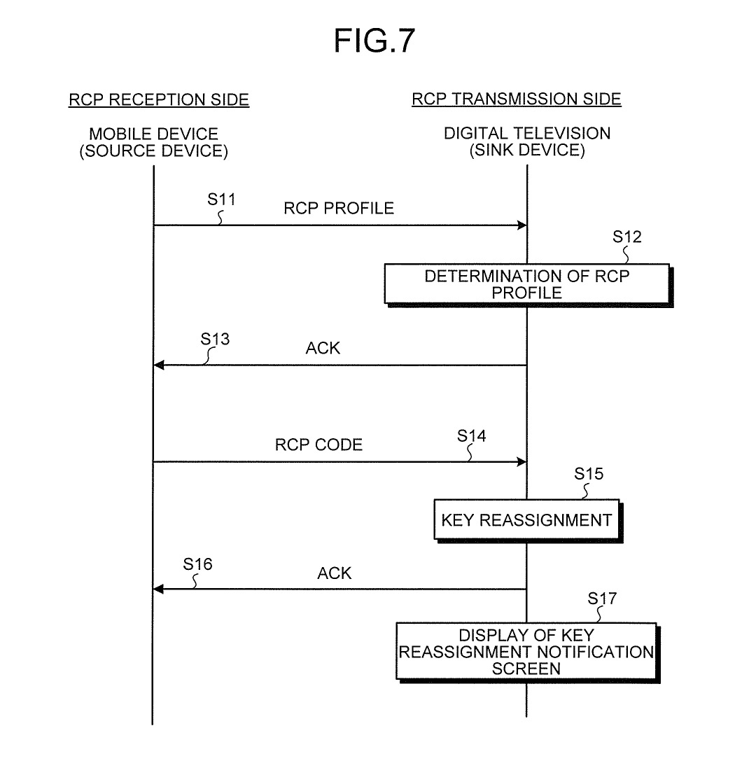

Next, an RCP command communication process by the communication system of the embodiment configured as described above will be described with reference to FIG. 7. First, the communication module 201 of the mobile device 200 transmits an RCP profile adapted to a type of itself stored in the storage module 202 to the digital television 100 (S11).

In the digital television 100 receiving the RCP profile, the determination module 101 determines whether the received RCP profile is supported by itself (S12). When it is supported, the input/output controller 16 transmits an ACK response to the mobile device 200 (S13). In the digital television 100, the RCP protocol is stored in the RAM 12.

In the mobile device 200 receiving the ACK response, the RCP profile corresponding to the type of itself is used thereafter. Hereinafter, a case where the RCP profile is supported by the digital television 100 is exemplified.

In addition, when the received profile is not supported by itself, the input/output controller 16 transmits a NACK response to the mobile device 200, and the mobile device 200 receiving the NACK response uses an RCP profile set as a default without using the RCP profile corresponding to the type of itself. Here, the RCP profile set as a default may be, for example, an RCP protocol of CEA931C, but is not limited thereto.

Then, in the mobile device 200, the communication module 201 reads the RCP code including the RCP command receivable by the mobile device 200 from the storage module 202, and transmits the RCP code to the digital television 100 (S14).

In the digital television 100, when the input/output controller 16 receives the RCP code, all the received RCP codes are stored in the RAM 12. The assignment module 102 reassigns the receivable RCP command included in the RCP code received from the mobile device 200 by the input/output controller 16, and the key of the remote controller 40, based on the RCP profile and the data of the assignment of the key of the remote controller 40 managed by the digital television 100 and the RCP command (S15).

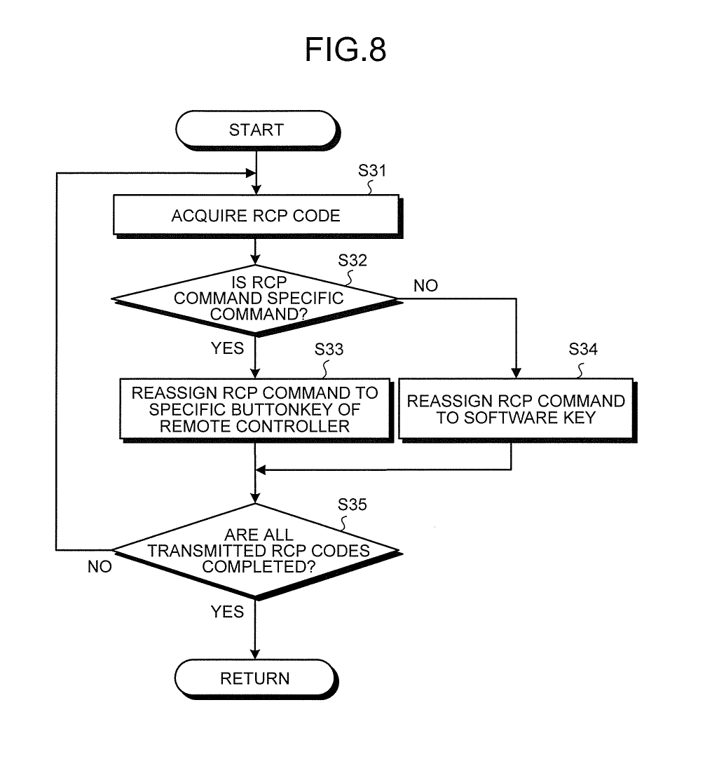

Here, the key reassignment process will be described in detail with reference to FIG. 8. First, as illustrated in FIG. 8, the assignment module 102 acquires the RCP code stored in the RAM 12 (S31).

The assignment module 102 determines whether the received RCP command is the specific command such as the command of the key operation constantly displayed on the screen of the mobile device 200 as described above (S32). When the received RCP command is the specific command (Yes in S32), the assignment module 102 reassigns the received RCP command to the specific key (for example, the key disposed at the position in the remote controller 40 where the user easily operates the keys as described above) of the remote controller 40 (S33).

Meanwhile, in S32, when the received RCP command is not the specific command (No in S32), the assignment module 102 reassigns the received RCP command to any one of the software keys (S34).

The assignment module 102 determines whether the processes for all the transmitted RCP codes stored in the RAM 12 are completed (S35). When the processes for all the RCP codes are not completed yet (No in S35), the processes from S31 to S34 are repeated.

Meanwhile, when the processes for all the transmitted RCP codes are completed (Yes in S35), the assignment module 102 normally ends the key reassignment process.

Referring again to FIG. 7, when the key reassignment is normally ended, the input/output controller 16 transmits an ACK response to the mobile device 200 (S16). The display processor 6 of the digital television 100 displays a key reassignment notification screen on the display module 7 by OSD by overlapping with the display image (S17). Accordingly, the user is notified of the key assignment, and convenience of the user is improved.

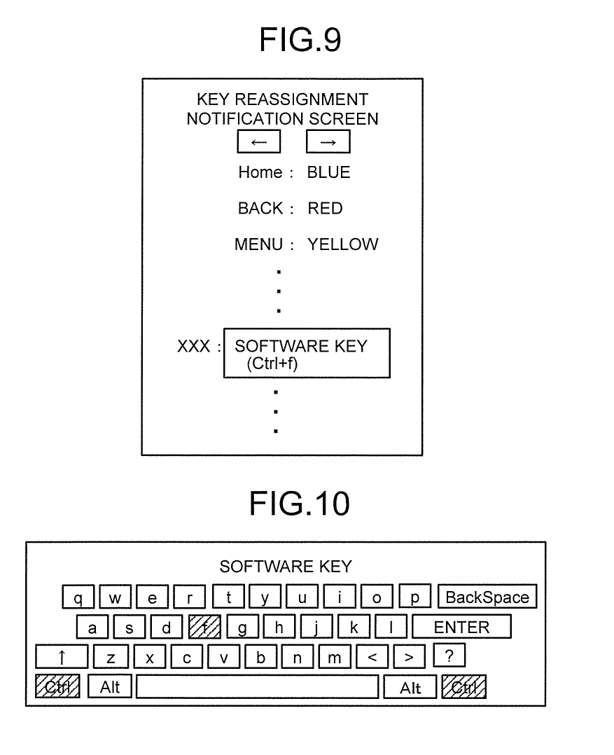

On the key reassignment notification screen, as illustrated in FIG. 9, the command name of the RCP command is associated with the assigned key of the remote controller 40 and is displayed. In the example of FIG. 9, the commands such as “Home”, “Back”, and “Menu” constantly displayed on the display face of the mobile device specific to Android OS as the specific RCP commands are assigned to blue, red, and yellow keys as specific keys disposed on the operation face of the remote controller 40. In addition, when there are a large number of key reassignments, which are over a plurality of screens, it returns to the previous screen by a right arrow key on the upper portion of the key reassignment notification screen, the key reassignment is displayed, it moves to the next screen by a left arrow key, and the key reassignment is displayed. In addition, the display processor 6 may be configured to display only the assignment of the reassigned key on the key reassignment notification screen, in addition to displaying the assignments of all the keys.

In addition, an RCP command of “XXX” is assigned to a software key. When the “software key” of the key assignment notification screen is pressed, the display processor 6 displays a screen representing the reassigned software key on the display module 7 as described in FIG. 10. In the example of FIG. 10, the reassigned is represented by diagonal lines.

In the embodiment as described above, the key assignment adapted to the mobile device 200 that is the RCP reception device is stored in advance in the storage module 202 of the mobile device 200 as the RCP profile, and the RCP protocol is transmitted to the digital television 100 that is the RCP transmission device. Accordingly, it is possible to reduce the undefined operation between the mobile device 200 and the digital television 100 by efficiently and easily assigning the command while keeping compatibility.

In addition, in the embodiment, the mobile device 200 that is the RCP reception device transmits the RCP code including the receivable RCP command to the digital television 100 that is the RCP transmission device, and the digital television 100 performs the key assignment based on the RCP profile and the receivable RCP command. Accordingly, it is possible to reduce the undefined operation between the mobile device 200 and the digital television 100 by efficiently and easily performing the assignment of the command while keeping compatibility.

In addition, the communication program executed in the digital television 100 of the embodiment is installed in advance in the ROM 13 and is provided.

The communication program executed in the digital television 100 of the embodiment may be recorded and provided in a computer-readable recording medium such as a CD-ROM, a flexible disk (FD), a CD-R, a DVD (Digital Versatile Disk) as files in an installable form or executable form.

In addition, the communication program executed in the digital television 100 of the embodiment may be stored on a computer connected to a network such as Internet and may be provided to be downloaded through the network. In addition, the communication program executed in the digital television 100 of the embodiment may be provided or distributed through a network such as Internet.

The communication program executed in the digital television 100 of the embodiment is configured as a module including the modules (the determination module 101 and the assignment module 102) described above, the controller 10 (the processor) reads and executes the communication program from the ROM 13, as actual hardware, the modules are loaded on a main storage device, and the determination module 101 and the assignment module 102 are generated on the RAM 12.

In addition, the invention is not limited to the embodiment as it is, and may be embodied by modifying constituent elements within the scope which does not deviate from the main concept in the embodying step. In addition, various inventions may be made by appropriate combination of the plurality of constituent elements disclosed in the embodiment. For example, several constituent elements may be removed from all the constituent elements described in the embodiment. In addition, constituent elements in the other embodiments may be appropriately combined.

As such modification examples, for example, there is the following. In the embodiment, two functions of the function of transmitting the RCP profile adapted to itself from the mobile device 200 to the digital television 100, and the function of transmitting the RCP command receivable by the mobile device 200 from the mobile device 200 to the digital television 100 and reassigning the key in the digital television 100 are performed as a series of processes, but the invention are not limited thereto. For example, the mobile device 200 and the digital television 100 may be configured to perform only any one function.

In addition, in the embodiment, when the key reassignment process is completed, the key reassignment notification screen illustrated in FIG. 9 and FIG. 10 is displayed on the display module 7. However, the display processor 6 may be configured so as to display such a key reassignment notification screen or the same key assignment notification screen representing a current key assignment state on the display module 7, at any timing. Any timing may be a timing when a predetermined key such as a link button of the remote controller 40 is pressed at a desired timing of the user, but is not limited thereto.

In addition, in the embodiment, as illustrated in FIG. 9 and FIG. 10, the key reassignment notification screen is displayed on the display module 7 of the digital television 100 to notify the user. However, when the user wants to change the key assignment on the screen, the assignment module 102 may be configured such that an instruction of changing the key assignment is performed in the digital television 100, and the key reassignment is changed by receiving the instruction.

In addition, in the embodiment, the example using the MHL standard and the RCP is described as an image transmission technique, but the invention is not limited to such a protocol.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device comprising:
a communication module configured to receive a profile in which a key for executing a command is associated with the command, and a command receivable by a reception device, from the reception device for receiving the command transmitted from the communication device and executing the command; and
an assignment module configured to assign the receivable command and the key based on the profile.

2. The communication device of claim 1, wherein the assignment module is configured to determine whether the receivable command is a specific command, and assigns the receivable command to a specific key of a remote controller when the receivable command is the specific command.

3. The communication device of claim 2, wherein
the specific command is a command associated with a key constantly displayed on an operation module of the reception device, and
the specific key is a key disposed at a position in the remote controller where a user easily operates the key.

4. The communication device of claim 2, wherein the assignment module is configured to assign the receivable command to a software key when the receivable command is a predetermined command other than the specific command.

5. The communication device of claim 4, wherein the predetermined command is a command having frequency in use of a user lower than a predetermined number of times.

6. The communication device of claim 1, further comprising a display processor configured to display assignment of the receivable command and the key on a display module.

7. The communication device of claim 1, further comprising
a storage module configured to assign the key to a command group which includes a predetermined command executable by the reception device, in advance,
wherein the assignment module is configured to assign the receivable command to the key assigned in advance to the command of the command group when the receivable command is different from the command of the command group.

8. A communication system comprising:
a transmission device configured to transmit a command; and
a reception device configured to receive the command from the transmission device and execute the command, wherein
the reception device comprises
a first communication module configured to transmit a profile in which a key for executing the command is associated with the command, and a command receivable by the reception device to the transmission device, and
the transmission device comprises
a second communication module configured to receive the profile and the receivable command from the reception device, and
an assignment module configured to assign the receivable command and the key based on the profile, and register the receivable command and the key in the storage module.
